(19) United States
(12) Patent Application Publication
(10) Pub. No.: US 2025/0250437 A1
(43) Pub. Date: Aug. 7, 2025

(54) SILICONE RUBBER PAD WITH EXCELLENT UNIFORMITY

(71) Applicant: RION CO., Ltd, Gyeonggi-do (KR)

(72) Inventors: Ku Chan Chung, Gyeonggi-do (KR); Ki Woong Park, Gyeonggi-do (KR); Seo Jeong Park, Gyeonggi-do (KR)

(21) Appl. No.: 19/011,871

(22) Filed: Jan. 7, 2025

(30) Foreign Application Priority Data
Feb. 6, 2024 (KR) 10-2024-0017992
Oct. 17, 2024 (KR) 10-2024-0142050

(51) Int. Cl. C08L 83/04

(52) U.S. Cl. CPC C08L 83/04

(57) ABSTRACT

Provided is a silicone resin pad having excellent uniformity enabling an electronic device such as a semiconductor chip to be mounted on substrate with excellent uniformity when the electronic device is pressed, the silicone resin pad has an elongation (%) in the range of 400 to 500 and a compression set (%) of 0.5 to 0.6, the silicone resin pad has a weight-average molecular weight (g/mol) of 40,000 to 60,000 and a number-average molecular weight (g/mol) of 1,000 to 2,000.

### CROSS-REFERENCE TO RELATED APPLICATION

This application claims priority of Korean Patent Application No. 10-2024-0017992, filed on Feb. 6, 2024, and priority of Korean Patent Application No. 10-2024-0142050, filed on Oct. 17, 2024, in the KIPO (Korean Intellectual Property Office), the disclosure of which is incorporated herein entirely by reference.

### BACKGROUND OF THE INVENTION

### Field of the Invention

The present invention relates to a silicone resin pad having excellent uniformity, and, more specifically, relates to a silicone resin pad having excellent uniformity, enabling an electronic device such as a semiconductor chip to be mounted on substrate with excellent uniformity when the electronic device is pressed.

### Description of the Related Art

Various packaging technologies are being developed according to the miniaturization of the semiconductor line width. However, in the packaging process, a technology of stacking a plurality of chips is essential, and in this case, a rubber-based pad such as a silicon resin is used.

However, since the silicon rubber pad has a large area, uniformity over the entire areas of the silicon rubber pad may be reduced when the silicon rubber pad is pressed for mounting electronic devices such as chips to a substrate. Therefore, it is necessary to develop a new silicon rubber pad capable of solving the problem mentioned above.

### SUMMARY OF THE INVENTION

Accordingly, an object to be achieved by the present invention is to provide a silicon resin pad having excellent uniformity and a method of manufacturing the same.

In order to achieve the object, the present invention provides a silicone resin pad prepared by curing a liquid silicone resin comprising dimethyl siloxane and methyl vinyl siloxane, wherein the silicone resin pad has an elongation (%) in the range of 400 to 500 after curing, a compression set (%) of 0.5 to 0.6, a weight-average molecular weight (g/mol) of the silicone resin pad is 40, 000 to 60, 000, a number-average molecular weight (g/mol) of the silicone resin pad is 1000 to 2000, and when the silicone resin pad is pressed at 90 kgf/cm². with a length of 50 cm or more, a step difference has a uniformity of within 70 μm.

In one embodiment of the present invention, the silicone resin pad is a pressing pad for semiconductor packaging.

In one embodiment of the present invention, the silicone resin pad has a size of 50 cm×50 cm or more.

In an embodiment of the present invention, the curing time of the silicone resin pad may be 5 minutes to 15 minutes, and the curing temperature may be 100 degrees Celsius.

The silicon pad in accordance with this invention may obtain excellent uniformity when pressed according to a combination of an elongation rate and a permanent compression coefficient, and may maintain a constant uniformity, particularly in a large part.

### BRIEF DESCRIPTION OF THE DRAWINGS

The above and other features and advantages will become more apparent to those of ordinary skill in the art by describing in detail exemplary embodiments with reference to the attached drawings, in which:

FIGS. 1 to 4 are compression test results of a silicon pad.

FIGS. 5 to 7 are the results of measuring the uniformity of pads measured while simultaneously increasing the length and width from 10 cm to 50 cm and 100 cm in Example, Comparative Example 1, and Comparative Example 3, respectively.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

### EXAMPLES

In one embodiment of the present invention, a liquid silicon rubber (LSR) was cured to a temperature of 100 degrees Celsius with a size of 100×100 cm and a thickness of 3 mm.

In the present invention, 50 to 60 parts by weight of methyl vinyl siloxane based on 100 parts by weight of dimethyl siloxane was cured in a curing mold at 150° C. for 5 minutes in the presence of a platinum catalyst (5 parts by weight) to prepare a liquid silicone rubber.

As a comparative example, the silicone resin was LSR, which is a liquid silicone rubber resin containing dimethyl and methyl vinyl siloxane copolymers, but the molecular weight thereof was different.

To this end, 10 parts by weight of methyl vinyl siloxane (Comparative Example 1) and 100 parts by weight of methyl vinyl siloxane were used based on 100 parts by weight of dimethyl siloxane, respectively, and a liquid silicone rubber was prepared by curing a platinum catalyst (5 parts by weight) at 150° C. for 5 minutes in a curing mold (Comparative Example 2).

In addition, the curing time was set to 20 minutes instead of 5 minutes, and the methyl vinyl siloxane was cured in an amount of 200 parts by weight based on 100 parts by weight of the dimethyl siloxane (Comparative Example 2).

The molecular weights of Examples and Comparative Examples are as follows.

TABLE 1

| | | Comparative | Comparative | Comparative |
|---|---|---|---|---|
| | Example | Example 1 | Example 2 | Example 3 |
| Number-Average | 1867 | 1564 | 2453 | 1953 |
| Molecular Weight | | | | |
| (g/mol) | | | | |
| Weight-Average | 51027 | 9130 | 10233 | 65323 |
| Molecular Weight | | | | |
| (g/mol) | | | | |

Molecular weight was measured by a method by GPC, and is a result of calculating molecular weight and distribution by setting a portion where baseline is close to 0 or a lowest point as an end point.

Referring to the results, there is a large difference in the number-average molecular weight between Examples and Comparative Examples.

### Experimental Example 1

In the present experimental example, an elongation (% modulus) according to ASTM D412 die-C and a compression set according to ASTM D 395 method-B were compared.

TABLE 2

| | Elongation (%) | Compression Set (%) |
|---|---|---|
| Example | 499 | 0.57 |
| Comparative Example 1 | 204 | 0.21 |
| Comparative Example 2 | 460 | 0.75 |
| Comparative Example 3 | 211 | 0.24 |

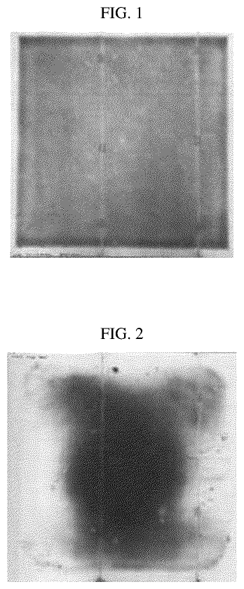

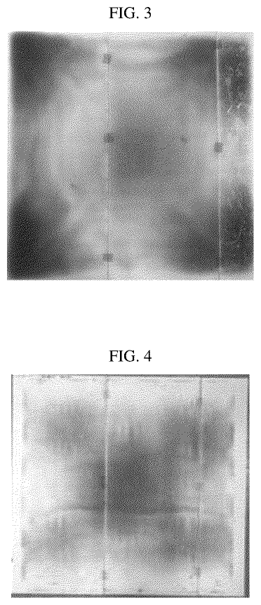

FIGS. 1 to 4 are compression test results of the silicon pads of Examples and Comparative Examples 1 to 3, respectively.

In an example of the present invention, the prepared silicon sheet was pressed by a metal plate on a pressure paper with a force of 90 kgf/cm².

Referring to FIGS. 1 to 4, a combination of an elongation of 400 to 500 and a compression set of 0.5 to 0.6 exhibits excellent uniformity. Here, the higher the color component, the stronger the pressure was applied.

In the case of Comparative Example 2 in which the elongation is similar to that of Example, since the compression set is more than 0.7, it may be seen that the uniformity is deteriorated. On the contrary, in the case of Comparative Example 3 having a similar compression set, the elongation was significantly higher than that of the silicon pad of the present invention, and in this case, the uniformity was not good compared to the present invention.

Therefore, the elongation of the silicone pad according to the present invention is in the range of 400 to 550%, and at the same time, the compression set is in the range of 0.5 to 0.65. If any one of these two conditions is out of the range, it is difficult to obtain desired uniformity (a step difference within 70 μm) as described above.

### Experimental Example 2

The silicon pad according to the present invention exhibits particularly excellent uniformity in a large area of a 100×100 cm level.

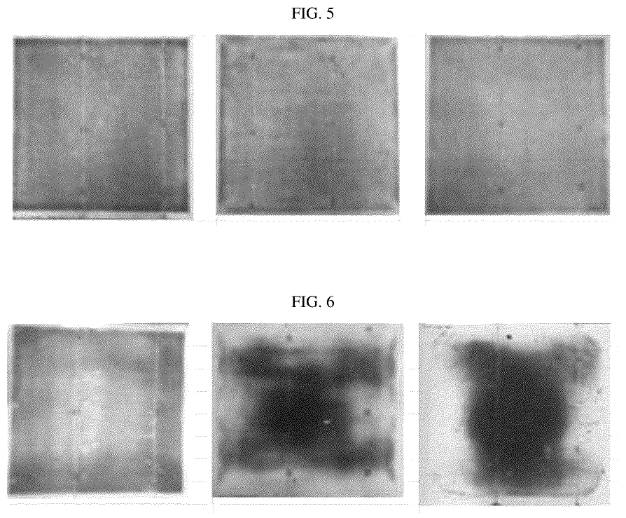

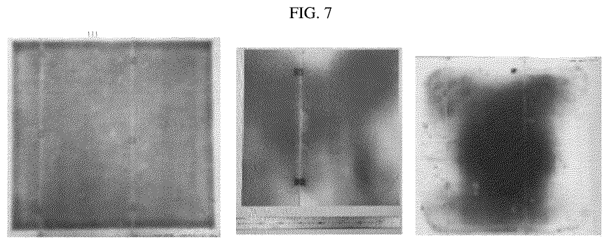

FIGS. 5 to 7 are the results of measuring the uniformity of the pad measured with a force of 90 kgf/cm² while simultaneously increasing the length and width from 10 cm to 50 cm and 100 cm in Example, Comparative Example 1, and Comparative Example 3, respectively.

Referring to FIGS. 5 to 7, as the size of the pad increases, the uniformity decreases in the case of Comparative Examples 1 and 3. However, it can be seen that in the case of the present invention, even though the size increases, the uniformity is kept constant. Therefore, it can be seen from the above results that the silicon pad according to an embodiment of the present disclosure has a uniformity in which a step difference in length and width (i.e., size) of at least 50 cm is within 70 μm.

In particular, when the weight-average molecular weight is 40, 000 to 60, 000 in terms of molecular weight, and at the same time, the number-average molecular weight is 2000 or less, preferably 1500 to 2000, it affects the uniformity when pressurizing a large area (at least 50 cm or more) of the silicon pad, which can be seen from the above experimental results. This suggests that the presence of a polymer having a long chain length with respect to the same weight (i.e., the wider the distribution of the polymer) is particularly advantageous for the uniformity of a large-area substrate when pressed.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims. The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A silicone resin pad prepared by curing a liquid silicone resin comprising dimethyl siloxane and methyl vinyl siloxane,
wherein an elongation (%) of the silicone resin pad after curing is in the range of 400 to 500, a compression set (%) is 0.5 to 0.6,
wherein a weight-average molecular weight (g/mol) of the silicone resin pad is 40,000 to 60,000, a number-average molecular weight (g/mol) is 1,000 to 2,000, and when the silicone resin pad is pressed at 90 kgf/cm² with a length of 50 cm or more, a step difference has a uniformity of within 70 μm.

2. The silicone resin pad of claim 1, wherein the silicone resin pad is a pressing pad for semiconductor packaging.

3. The silicone resin pad of claim 2, wherein the silicone resin pad has a size of 50 cm×50 cm or more.

4. The silicone resin pad of claim 1, wherein the silicone resin pad has a curing time of 5 minutes to 15 minutes, and a curing temperature of 100 degrees Celsius.
